(19) United States
(12) Patent Application Publication
(10) Pub. No.: US 2019/0333087 A1
(43) Pub. Date: Oct. 31, 2019

(54) METHODS AND SYSTEMS FOR TRACKING AND REWARDING DISTRIBUTORS OF GIFT CARDS

(71) Applicant: PAYMENT INSIGHTS LLC, Fremont, CA (US)

(72) Inventor: Rajiv Venkataramana APPANA, Fremont, CA (US)

(21) Appl. No.: 15/965,942

(22) Filed: Apr. 29, 2018

(51) Int. Cl. G06Q 30/02; G06Q 20/34

(52) U.S. Cl. CPC G06Q 30/0207; G06Q 20/348

(57) ABSTRACT

A method and system for tracking and rewarding distributors and/or distribution partners is disclosed. The method includes receiving a gift card redemption request for funding a subscription account associated with a customer. The gift card redemption request comprises a gift card identifier and a gift amount associated with a gift card for availing a subscription service using the subscription account. The method also includes determining if the subscription account created by the customer is a new subscription account. Further, the method includes tracking the subscription account by assigning a customer identifier for the subscription account, acquiring a subscription service amount for the subscription service availed by the customer and identifying a distributor associated with sale of the gift card to the customer. Furthermore, the method includes facilitating calculation of incentive for the distributor based at least on the subscription service amount and the gift amount.

### TECHNICAL FIELD

The present disclosure generally relates to gift cards and, more particularly to, methods and systems for tracking and rewarding distributors and/or distribution partners of gift cards for subscription services.

### BACKGROUND

Gift cards are an integral part of our society and they provide a great way for consumers looking to gift something that is personal and can still give the gift recipients to pick what they want. Consumers use gift card not just for gifting, but also for other reasons such as budgeting, business gifting, family expense management, scrip programs (fund raising), incentives (sales incentives), rebate programs and loyalty card redemption options. Currently, most retailers offer gift cards for sale so that they can acquire new customers.

Gift cards are sold at locations outside of the retailer and give consumers the convenience of buying gift cards at locations they visit frequently. For example, a gift card issued by a retailer may be sold at distribution locations by distributors or at other retail outlets by distribution partners. Retailers whose gift cards are being sold essentially allow customers to pre-pay for the purchase, acquire new customers to be part of a gift transaction even without a physical store in close proximity and participate in the loyalty program of the retailer at which the gift cards are being sold. The distributors and/or distribution partners sell gift cards because it allows them to make extra revenue by sale of gift cards.

With the increase in growth of e-commerce, ability to personalize and pay online has led to the demand for subscription services. Subscription services allow customers to get products of high quality on a recurring basis and in many cases provides an element of surprise. Given the recurring revenue that subscription businesses generate, the lifetime value of a customer is high. However, overcoming the challenge of getting customers to subscribe is very high and the cost of customer acquisition often runs many times the monthly fee.

Gift cards for subscription services provide an option for customers to try and buy subscription services when sold via distributors and/or distribution partners. Although the business of gift cards for subscription service is attractive, the challenge for subscription businesses is that most of the times the distributor/distribution partner will not accept the gift cards to be sold in their locations. This is primarily because distributors and/or distribution partners will only make 10%-20% of the sale of the gift card and not enough customers buy the gift cards for subscription services. However, the subscription businesses heap high profits in acquisition of every new customer that signs up for the subscription services.

In view of the above, there is a need for tracking and rewarding distributors and/or distribution partners who play a role in acquisition of a new customer for a subscription service.

### SUMMARY

Various embodiments of the present disclosure provide methods and systems for tracking and rewarding distributors and/or distribution partners.

In an embodiment, a method is disclosed. The method includes receiving a gift card redemption request for funding a subscription account associated with a customer. The gift card redemption request comprises a gift card identifier and a gift amount. The gift amount is associated with a gift card for availing a subscription service using the subscription account. The method further includes determining if the subscription account created by the customer is a new subscription account. The creation of new subscription account indicates acquisition of a new customer for the subscription service. The method further includes tracking the subscription account by assigning a customer identifier for the subscription account, acquiring a subscription service amount for the subscription service availed by the customer using the subscription account and identifying a distributor associated with sale of the gift card to the customer. Furthermore, the method comprises facilitating calculation of an incentive for the distributor based on the subscription service amount and the gift amount.

In another embodiment, a device is disclosed. The device includes a memory and a processor. The memory comprises stored instructions. The processor in the device is configured to execute the stored instructions to perform the method. The method includes receiving a gift card redemption request for funding a subscription account associated with a customer. The gift card redemption request comprises a gift card identifier, a gift card activation identifier and a gift amount. The gift amount is associated with a gift card for availing a subscription service using the subscription account. The method further includes determining if the subscription account created by the customer is a new subscription account. The creation of new subscription account indicates acquisition of a new customer for the subscription service. The method further includes tracking the subscription account by assigning a customer identifier for the subscription account, acquiring a subscription service amount for the subscription service availed by the customer using the subscription account and identifying a distributor associated with sale of the gift card to the customer. Furthermore, the method comprises facilitating calculation of an incentive for the distributor based on the subscription service amount and the gift amount.

In yet another embodiment, a method is disclosed. The method includes receiving, by a program manager, a gift card redemption request from an issuer server. The gift card redemption request comprises at least one of a gift card identifier and a gift card activation identifier of a gift card for funding a subscription account associated with a customer. The subscription account associated with a subscription service offered by the issuer server. The method also includes determining, by the program manager, if the subscription account created by the customer is a new subscription account by retrieving subscription account details from the issuer server. The new subscription account indicating acquisition of a new customer for the subscription service. Further, the method includes acquiring, by the program manager, a subscription service amount from the issuer server. The subscription service amount associated with the subscription service by tracking the new subscription account. Furthermore, the method includes calculating, by the program manager, a monetary reward for at least one distributor associated with the gift card based at least on the subscription service amount and the gift amount.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 represents a sequence flow diagram depicting activation of a gift card, in accordance with an example embodiment;

FIG. 3 represents a sequence flow diagram depicting redemption of the gift card for a subscription service, in accordance with an example embodiment;

FIG. 4 is a simplified representation of a table maintained in a program manager, in accordance with an example embodiment;

FIG. 5 is a flow diagram depicting an example method for rewarding distributors and/or distribution partners for sale of gift cards for subscription service, in accordance with an example embodiment; and

FIG. 6 is a block diagram of a server system configured to track and reward distributors and/or distribution partners for sale of gift cards used for availing subscription services, in accordance with an example embodiment.

The drawings referred to in this description are not to be understood as being drawn to scale except if specifically noted, and such drawings are only exemplary in nature.

### DETAILED DESCRIPTION

Various methods and systems for tracking and rewarding distributors and/or distribution partners of gift cards for subscription service are disclosed.

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various embodiments of the present disclosure provide methods, systems, user devices and computer program products for rewarding distributors and/or distribution partners of gift cards for subscription services. The gift cards are issued by an issuer associated with the subscription service. The gift card is sold by distributors at distribution outlets. Alternatively, the distributors assign sale of the gift cards to distribution partners and agree with the distributor partners on dividing the monetary benefits earned by sale of the gift cards.

When the user purchases the gift card, the distributor or the distribution partner can activate the gift card for the user by sending a gift card activation request on behalf of the user to the issuer server via a program manager. The gift card activation request includes a gift card identifier and a gift amount to be loaded on the gift card. Alternatively, if the gift card includes a proxy identifier, then a distributor server resolves the proxy identifier to determine an associated gift card identifier. In an embodiment, the gift card activation request is sent by the distribution partner to the distributor server associated with the distributor. The distributor server forwards the gift card activation request to the issuer server. In another embodiment, the distributor server sends the gift card activation request to the program manager. It shall be noted that the program manager is a processor that may be a stand alone component or operations of the program manager may be embodied in the issuer server and/or distributor server for activating the gift card based on the gift card activation request. The gift card is activated by the issuer server and the issuer server generates a gift card activation identifier that is stored in the program manager. The program manager maintains a transaction data wherein transaction details pertaining to the gift card are stored. The transaction details include information such as, the gift card identifier, the gift card activation identifier, the gift amount, balance amount after every purchase using the gift card and the distributor and/or distribution partner who sent the gift card activation request to the issuer server.

When the user accesses an issuer interface for availing a subscription service offered by the issuer server using the gift card, the user is prompted to either create a subscription account or log in with credentials to access the subscription account created prior by the user. If the user chooses to create a new subscription account and uses the gift card of the issuer (purchased from the distributor or the distribution partner) as a mode to pay for the subscription service, the program manager receives a gift card redemption request from the issuer server (associated with the issuer) for payment transaction. The redemption request comprises the gift card identifier, the gift amount and optionally the gift card activation identifier associated with the gift card. Upon receipt of the gift card redemption request for funding the new subscription account created by the user, the program manager identifies that a new customer acquisition has happened due to sale of the gift card and retrieves the transaction details associated with the gift card. The transaction details provide details of the distributor and/or distribution partner associated with sale and activation of the gift card to the user.

In an embodiment, the program manager assigns a customer identifier to the subscription account if the subscription account is created by the user for a first time and funded by the gift card. The customer identifier is used to track subscription details, subscription amount and payment information associated with the subscription account funded by the gift card for availing the subscription service. The program manager is configured to calculate incentives for the distributor and/or the distribution partner based on the gift amount and the subscription amount. In an embodiment, the program manager uses the gift amount of the gift card to compute a distribution fee for the distributor and/or the distribution partner. The distribution fee is a one-time commission in form of a monetary reward to the distributor and/or distribution partner for sale of the gift card. The program manager uses the subscription details and the subscription amount to compute a finder fee for the distributor and/or the distribution partner. The finder fee is at least one of a one-time incentive or an ongoing commission based on the subscription service availed by the customer using the gift card.

“Gift cards” or “subscription service gift cards” refer to cards used as a method of payment for performing transactions and availing subscription services from an issuer. As described herein, the term “gift card” includes cards such as, but not limited to, prepaid cards or loyalty/rewards cards used for availing subscription services. Virtual gift cards delivered via email or short message service or accessed via an application installed on mobile phones, personal digital assistants (PDAs), and key fobs may fall within the scope of the term “gift cards” or “subscription service gift cards”. The transactions performed using the gift cards for availing subscription services are referred to as “financial transactions” or “payment transaction”. An example of a financial transaction may include making payment using the gift card at an issuer interface for availing the subscription service using online transactions. The terms “user” or “consumer” have been used interchangeably throughout the description and refer to a person availing a subscription service from the issuer using the gift card.

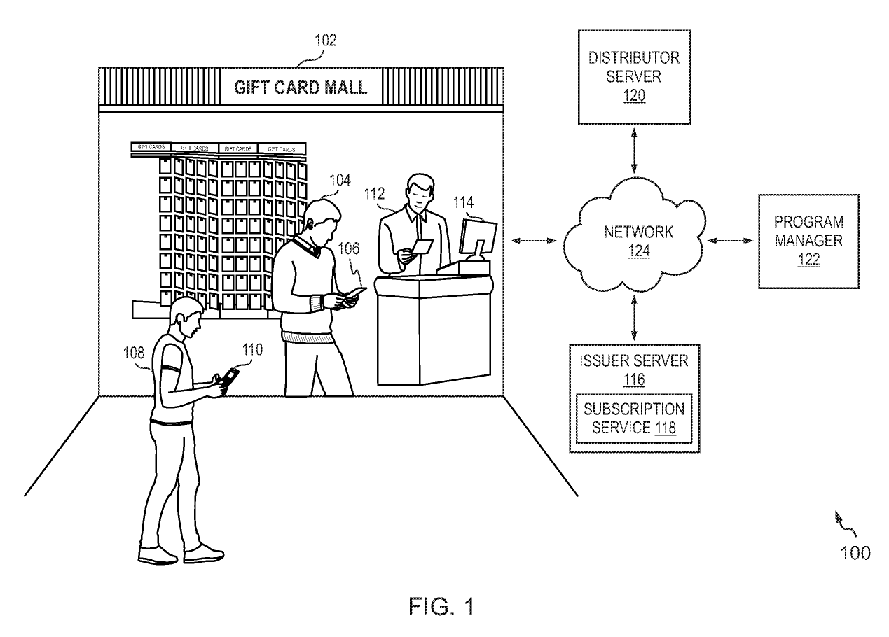

FIG. 1 illustrates an environment 100, in accordance with an example embodiment. An example representation of the environment 100 is shown depicting a communication network (e.g., a network 124) that connects entities such as, a merchant facility 102, an issuer server 116, a distributor server 120 and a program manager 122. The network 124 may be a centralized network or may comprise a plurality of sub-networks that may offer a direct communication between the entities or may offer indirect communication between the entities. Examples of the network 124 include stand alone or a combination of a local area network (LAN), a wide area network (WAN), wireless, wired, any currently existing or to be developed network that can be used for communication. More specifically, an example of the network 124 can be the Internet which may be a combination of a plurality of networks.

In the illustrated embodiment, the merchant facility 102 selling gift cards on a rack for subscription services is shown. The merchant facility 102 may be managed by a merchant such as a merchant 112, a group of merchants or an agent. Examples of the merchant facility 102 may include any retail shop, supermarket or business establishment, fuel stations, private agencies, ticket counters, or any such place or establishment where customers visit for purchasing goods and/or services. The merchant facility 102 is an example of a distribution partner who is authorized to sell gift cards for subscription services by a distributor or an issuer.

As shown in FIG. 1, a user 104 picks a gift card 106 for a subscription service 118 from the rack at the merchant facility 102. The subscription service 118 is offered by an issuer including, but not limited to, Spotify®, Netflix®, iTunes®, Kindle, Amazon Prime® and BirchBox®. In an embodiment, the issuer server 116 associated with the issuer can be accessed to avail the subscription service 118 offered by the issuer. The gift card 106 has no value until the gift card 106 is activated. When the user 104 performs a financial transaction, and pays for the gift card 106 at the merchant facility 102, the gift card 106 is activated and the gift amount (funds) is loaded onto the gift card 106. The gift card 106 has an associated gift card identifier that aids in identifying the gift card. In an embodiment, the gift card includes a proxy identifier. For instance, the merchant facility 102 may sell gift cards of different issuers offering different subscription services. The distributor may therefore create a unique proxy identifier for each of the gift cards and creates a mapping between the gift card identifier and the proxy identifier. The mapping between the gift card identifier and the proxy identifier are maintained as a table at the distributor server 120. The proxy identifier of the gift card may be an activation bar code and is usually printed on piece of cardboard or plastic that holds the gift card 106.

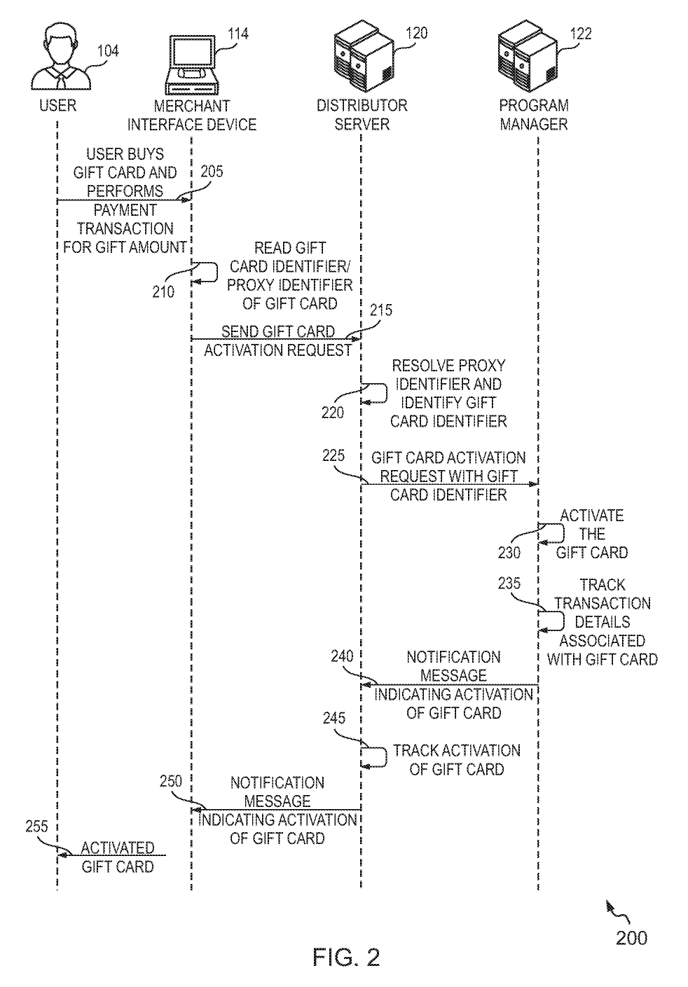

As shown in FIG. 1, the merchant facility 102 is equipped with a merchant interface device 114 managed by the merchant 112 (or an agent). In various embodiments, the merchant interface device 114 can be a telephone or a computer system operated by the merchant 112 (or an agent) for activating gift cards and processing payment transactions. As seen in FIG. 2, the merchant interface device 114 is a computer system operated by the agent 112. When the user 104 pays for the gift card 106, the merchant interface device 114 sends a gift card activation request on behalf of the user 104 to the issuer server 116 associated with the issuer of the gift card 106. The gift card activation request comprises a gift card identifier and a gift amount to be loaded on the gift card 106. The gift card identifier is either read from a chip provided on some gift cards or from a magnetic stripe provided in some other gift cards. Alternatively, when the gift card identifier is visibly printed on the gift card 106, then the merchant 112 may key in the gift card identifier on the merchant interface device 114. It shall be noted that the merchant interface device 114 scans/reads the gift card identifier or the proxy identifier in the gift card 106 for sending the gift card activation request to the issuer server 116.

The issuer server 116 receives the gift card activation request from the merchant interface device 114 and activates the gift card 106 by loading the funds onto the gift card 106 and generates a gift card activation identifier. The merchant interface device 114 sends the gift card activation request to the distributor server 120 and the distributor server 120 may resolve the proxy identifier of the gift card 106 to identify the gift card identifier. In an embodiment, the issuer server 116 may send the gift card activation request comprising the gift card identifier to the program manager 122 for activating the gift card 106. In an example, the program manager 122 may be a third party service managing services related to gift cards provided by the issuer. In an embodiment, the issuer server 116 forwards the gift card activation request to the distributor server 120 if the issuer server 116 identifies the proxy identifier of the gift card 106. The issuer server 116 requests the distributor server 120 to resolve the proxy identifier and sends a corresponding gift card identifier. In an embodiment, the distributor server 120 resolves the gift card 106 if the gift card activation request has a proxy identifier. For instance, the distributor server 120 looks up in the table to identify the gift card identifier corresponding to the proxy identifier read by the merchant interface device 114 from the gift card 106. In an embodiment, the issuer server 116 receives the gift card activation request and forwards the gift card activation request to the program manager 122. It shall be noted that the program manager 122 may resolve the gift card identifier and activate the gift card 106 to generate a gift card activation identifier. Additionally or optionally, the issuer server 116 and/or the program manager 122 store the transaction details associated with the gift card 106, such as, the gift card identifier, the gift amount, the gift card activation identifier and the merchant facility 102 (distribution partner). Thereafter, the issuer server 116 and/or the program manager 122 are configured to track purchases made using the gift card 106 and determine balance amount in the gift card 106 after every purchase.

The user 104 may gift the gift card 106 (associated with the subscription service 118) to a friend (referred to as a ‘user 108’). The user 108 may have one or more mobile devices, for example, the user 108 has a device 110. Examples of the device 110 are not limited to mobile phones only, and the device 110 may take examples of any portable electronic device (e.g., laptops, smartphones and tablets) having cellular communication capabilities. The user 108 can redeem the gift card 106 of the issuer by accessing an issuer interface via the device 110. The issuer interface provides options for availing the subscription service 118 offered by the issuer. For instance, the issuer interface displays various schemes, payment options, subscription content and subscription time duration for availing the subscription service 118. In an example, the issuer may provide a variety of subscription content, for example, television shows in different genres, such as, comedy, adventure and drama. The issuer interface may also provide flexible payment options for the subscription service 118, such as yearly installment, monthly installment or every 6 months and options for subscription time duration, such as a month, 6 months or yearly. In an embodiment, an instance of the issuer interface is provided by the issuer server 116 and can be installed by the user 108 on the device 110.

When the user 108 accesses the issuer interface, the issuer interface requests the user 108 to either create a subscription account or login using credentials to access subscription account (if already created) of the user 108. If the user 108 chooses to create a new subscription account, the issuer server 116 sends a notification to the program manager 122 to track the new subscription account of the user 108. The program manager 122 sets a customer identifier at the new subscription account of the user 108 to track the subscription details associated with the new subscription account of the user 108. The user 108 can choose from various schemes, payment options, subscription content and subscription time durations of the subscription service 118 provided on the issuer interface. The subscription details of the user 108 along with activation details (transaction details) are stored against the customer identifier in a table maintained at the program manager 122. The table ensures that the distributor and/or distribution partner associated with the sale of the gift card 106 are tracked and incentivized for acquiring a new customer to the subscription service 118. It shall be noted that creation of the new subscription account that is funded by the gift card 106 indicates acquisition of a new customer for the subscription service 118 offered by the issuer. It must be noted that the operations of the program manager 122 may be embodied in the issuer server 116 and/or the distributor server 120.

In an embodiment, the merchant interface device 114 reads a proxy identifier of the gift card 106. For instance, the merchant facility 102 may sell gift cards of different issuers offering subscription services and hence a proxy identifier allows the agent 112 at the merchant facility 102 to determine a distributor and/or distributor partner for routing of the gift card activation request. In addition, the gift cards hanging on a peg may expose the gift card identifier in plain text that may be used for fraudulent services. The distributor may therefore create a unique proxy identifier for each of the gift cards and creates a mapping between the gift card identifier and the proxy identifier. In an embodiment, the distributor server 120 manages a table that maps every proxy identifier to a gift card identifier. The proxy number for the gift card may include an activation bar code and is usually printed on piece of cardboard or plastic that holds the gift card 106. It shall be noted that the merchant interface device 114 scans/reads the gift card identifier or the proxy identifier in the gift card 106.

The distributor and/or the distribution partner associated with the sale of the gift card 106 are incentivized by the issuer for acquisition of the new customer (the user 108). For instance, the merchant facility 102 (distribution partner) is incentivized for sale of the gift card 106 that introduced the customer (the user 108) to the subscription service 118 offered by the issuer. The program manager 122 is configured to calculate incentive for the merchant facility 102 based on the gift amount and the subscription amount. In an embodiment, the program manager 122 uses the gift amount of the gift card 106 to compute a distribution fee for the merchant facility 102. The distribution fee is a one-time commission in form of a monetary reward to the merchant facility 102 for sale of the gift card 106. The program manager 122 uses the subscription amount to compute a finder fee for the distributor and/or the distribution partner. The finder fee is at least one of a one-time incentive or an ongoing commission based on the subscription details and the subscription amount of the subscription service 118 availed by the user 108 using the gift card 106 for the merchant facility 102.

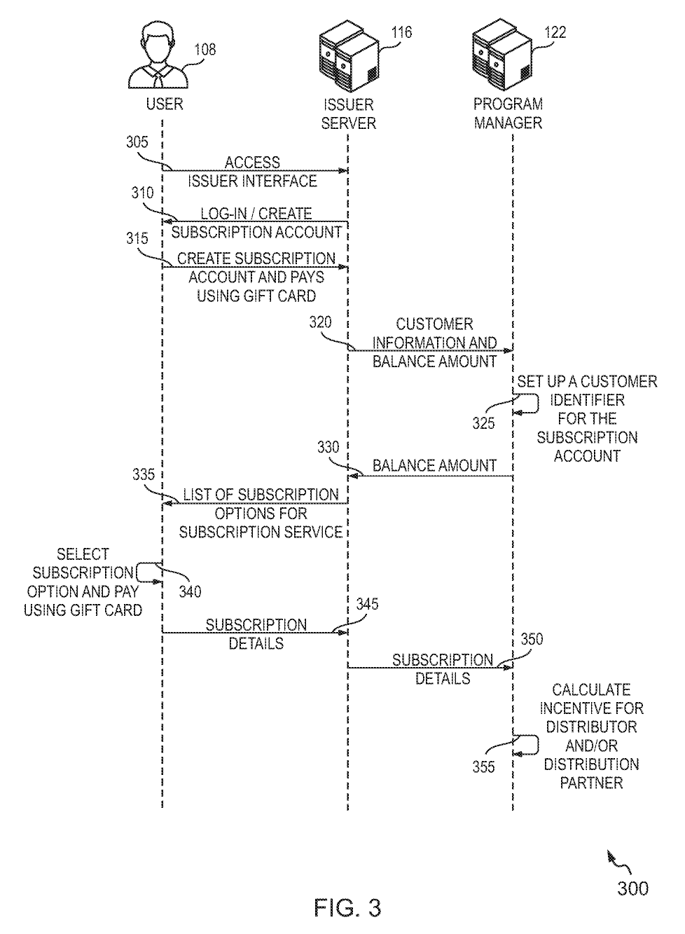

A non-exhaustive example embodiment of activating the gift card 106 and redeeming the gift card 106 will be described with reference to FIGS. 2 and 3.

FIG. 2 represents a sequence flow diagram 200 depicting activation of a gift card, in accordance with an example embodiment. It shall be noted that operations performed by the program manager 122 may be embodied in the issuer server 116 and/or the distributor server 120. The user 104 picks a gift card 106 from a rack at the merchant facility 102.

At 205, the user 104 buys the gift card 106 from the merchant facility 102 and performs a payment transaction corresponding to gift amount that is to be loaded on the gift card 106 at the merchant facility 102.

At 210, the merchant interface device 114 reads a gift card identifier on the gift card 106. In an embodiment, the merchant interface device 114 reads a proxy identifier of the gift card 106. For instance, the merchant facility 102 may sell gift cards of different issuers offering subscription services. The distributor may therefore create a unique proxy identifier for each of the gift cards and creates a mapping between the gift card identifier and the proxy identifier. In an embodiment, the distributor server 120 manages a table that maps every proxy identifier to a gift card identifier. The proxy identifier for the gift card 106 may include an activation bar code and is usually printed on piece of cardboard or plastic that holds the gift card 106. It shall be noted that the merchant interface device 114 scans/reads the gift card identifier or the proxy identifier in the gift card 106. The gift card identifier of the gift card 106 is stored in a chip or magnetic stripe of the gift card 106. The agent 112 may key-in the gift card identifier or the proxy identifier in the merchant interface device 114. Alternatively, or additionally, the agent 112 may swipe the gift card 106 in a POS machine available at the merchant facility 102 to read the gift card identifier or the proxy identifier.

At 215, the merchant interface device 114 sends a gift card activation request to the distributor server 120. The gift card activation request includes the gift amount that has to be loaded on the gift card 106 and the gift card identifier. Alternatively, the gift card activation request may include the gift amount that has to be loaded on the gift card 106 and the proxy identifier of the gift card 106. The distributor associated with the distributor server 120 assigns the merchant facility 102 (distribution partner) for sale of the gift card 106. The distributor and the distribution partner (the merchant facility 102) may agree on sharing monetary benefits (incentives) among themselves for sale of gift cards.

At 220, the distributor server 120 optionally resolves the proxy identifier to identify the gift card identifier of the gift card 106. The distributor server 120 accesses the table to determine the gift card identifier that corresponds to the proxy number of the gift card.

At 225, the distributor server 120 forwards the gift card activation request to the program manager 122. At 230, the program manager 122 activates the gift card 106 upon receiving the gift card activation request.

At 235, the program manager 122 tracks transaction details associated with the gift card 106. The transaction details include information pertaining to gift card identifier, gift amount in the gift card 106, balance amount in the gift card 106, activation location, distributor and/or distribution partner (the merchant facility 102) associated with activation of the gift card 106. The program manager 122 tracks balance in the gift card 106 after every purchase using the gift card 106.

At 240, the program manager 122 sends a notification message indicating activation of the gift card 106 to the distributor server 120. At 245, the distributor server 120 additionally or optionally, tracks the activation of the gift card 106 for tracking balance amount in the gift card 106.

At 250, the notification message indicating activation of the gift card is forwarded by the distributor server 120 to the merchant interface device 114. At 255, the user 104 receives an activated gift card 106.

FIG. 3 represents a sequence flow diagram 300 depicting redemption of the gift card for a subscription service 118, in accordance with an example embodiment. The user 104 who purchased the gift card 106 from the merchant facility 102, activates the gift card 106 and gifts it to a friend (the user 108).

At 305, the user 108 accesses an issuer interface to avail a subscription service, such as the subscription service 118 using the gift card 106. In an embodiment, the issuer interface is hosted and managed by the issuer server 116. The issuer server 116 provides an instance of the issuer interface to be installed on a device (e.g., the device 110) associated with the user 108.

At 310, the issuer server 116 requests the user 108 to create a subscription account or login using credentials into a subscription account created prior by the user 108. The issuer interface requires the user 108 to register with the issuer interface. The user 108 can either choose to login using credentials if he/she has an already existing subscription account.

At 315, the user 108 creates a subscription account and chooses to pay using the gift card 106. The user 108 provides credentials to create the subscription account on the issuer interface for availing the subscription service 118 provided by the issuer. Additionally, the user 108 chooses to fund the subscription service 118 using the gift card 106.

At 320, the issuer server 116 shares customer information with the program manager 122 and requests balance amount in the gift card 106 from the program manager 122. When the user 108 creates the subscription account and chooses to fund the subscription service 118 using the gift card 106, the issuer server 116 identifies that a new customer acquisition has happened for the subscription service 118 due to sale of the gift card 106. Therefore, the issuer server 116 shares customer information, such as, subscription account and gift card identifier to the program manager 122. The issuer server 116 provides the gift card identifier such that the program manager 122 can check the balance amount in the gift card 106.

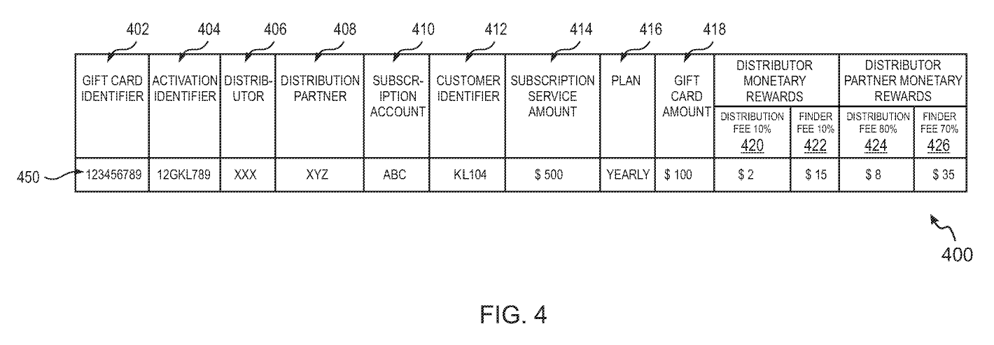

At 325, the program manager 122 sets up a customer identifier for the subscription account created by the user 108. The program manager 122 assigns the customer identifier to the subscription account such as to track the subscription account of the user 108. In an embodiment, the program manager 122 manages a table that provides details such as, gift card identifier, distributor, distribution partner, gift card activation identifier, financial transactions, payment details and details of the subscription service 118 against the customer identifier set for the subscription account. An example of the table is shown and explained with reference to FIG. 4.

At 330, the program manager 122 returns balance amount in the gift card 106 to the issuer server 116. The program manager 122 is configured to manage payment transactions of the gift card 106 and therefore the program manager 122 maintains a payment log. The payment log is used to determine the balance amount in the gift card 106.

At 335, the issuer server 116 provides a list of subscription options to the user 108 for availing the subscription service 118. For instance, the subscription service may provide various subscription options, such as payment options, subscription time period, subscription content and the like.

At 340, the user 108 selects a subscription option for the subscription service 118 and performs a payment transaction for the subscription service 118 by performing at least a part payment using the balance amount in the gift card 106. The issuer server 116 determines payment amount based on the subscription option selected by the user 108 for the subscription service 118. The payment transaction for the subscription service 118 is performed by choosing the gift card 106 as the mode of payment for the payment transaction.

At 345, the issuer server 116 receives subscription details of the user 108. At 350, the subscription details of the user 108 are provided to the program manager 122.

At 355, the program manager 122 calculates incentive for distributor and/or distribution partner associated with sale of the gift card 106. The sale of the gift card 106 by the merchant facility 102 has enabled acquisition of a new customer for the subscription service 118 offered by the issuer. In such cases, the merchant facility 102 (distribution partner) and/or the distributor who helped acquisition of the new customer (the user 108) are incentivized. For example, the program manager 122 calculates incentives for the merchant facility 102 based on the gift amount and the subscription amount. In an embodiment, the program manager 122 uses the gift amount of the gift card 106 to compute a distribution fee for the merchant facility 102. The distribution fee is a one-time commission in form of a monetary reward to the merchant facility 102 for sale of the gift card 106. The program manager 122 uses the subscription amount to compute a finder fee for the merchant facility 102 based on the subscription details and the subscription amount. The finder fee is at least one of a one-time incentive or ongoing commission based on the subscription details of the subscription service 118 availed by the user 108 using the gift card 106. In an embodiment, the distribution fee is provided to the distributor and/or distribution partner when the gift card is activated by the issuer server 116. Alternatively, the distribution fee and the finder fee are computed and provided to the distributor and/or distribution partner after the user 108 completes payment transaction for the subscription service 118 availed using the subscription account.

Referring now to FIG. 4, a simplified representation of a table 400 maintained in the program manager 122 is illustrated in accordance with an example embodiment. As seen in FIG. 4, the table 400 includes listings of gift card identifier, gift card activation identifier, an associated distributor, an associated distribution partner, an associated subscription account, a customer identifier, subscription service amount, subscription service plan, gift card amount and monetary reward in form of distribution fee and finding fee for distributor and distribution partner. It shall be noted that the table 400 shown in FIG. 4 is only exemplary and for the purposes of explanation. In practical, a database in the program manager 122 may include multiple such tables and each table may have more or less columns and rows than depicted in FIG. 4.

The table 400 includes columns representing a gift card identifier 402, an activation identifier field 404, a distributor field 406, a distribution partner field 408, a subscription account field 410, an customer identifier field 412, a subscription service amount field 414, a subscription plan field 416, a gift card amount field 418, a distribution fee field for the distributor 420, a finder fee field for the distributor 422, a distribution fee field for the distribution partner 424 and a finder fee field for the distribution partner 426.

As an example, a row 450 depicts that for a gift card with gift card identifier “123 456 789” the activation identifier is “12GKL789” for a gift amount of $100, one of the associated distributor “XXX” and the distribution partner “XYZ” associated with the sale of the gift card. The subscription account “ABC” created by the user associated with the gift card is provided a customer identifier “KL#104”. The user avails the subscription service for a subscription plan “yearly” and at a subscription amount ($500) shown in the subscription service amount field 414. The monetary rewards for each of the distributor and/or the distribution partner for each of sale of gift card (distribution fee) and acquisition of new customer (finder fee) is listed under fields 420, 422, 424, 426.

According to the agreement, the issuer agrees to pay the distributor (XXX) 10% of the gift amount associated with the gift card as distribution fees. The distributor (XXX) and the distribution partner (XYZ) agree on 80% commission split. Therefore, the distributor partner (XYZ) receives $8 and the distributor (XXX) receives $2 as distribution fee for sale of the gift card. Similarly, the issuer may agree to pay a one-time commission or an ongoing commission for acquisition of the new customer for the subscription service offered by the issuer to the distributor (XXX) and/or the distribution partner (XYZ). In this example representation, the issuer agrees to pay 15% of the subscription amount as a one-time commission (finder fee) to the distributor (XXX) who in turn agrees to share 70% of the 10% commission with the distribution partner (XYZ). Therefore, the distribution partner (XYZ) receives $35 and the distributor (XXX) receives $15 as finder fee when the user avails subscription services using the gift card.

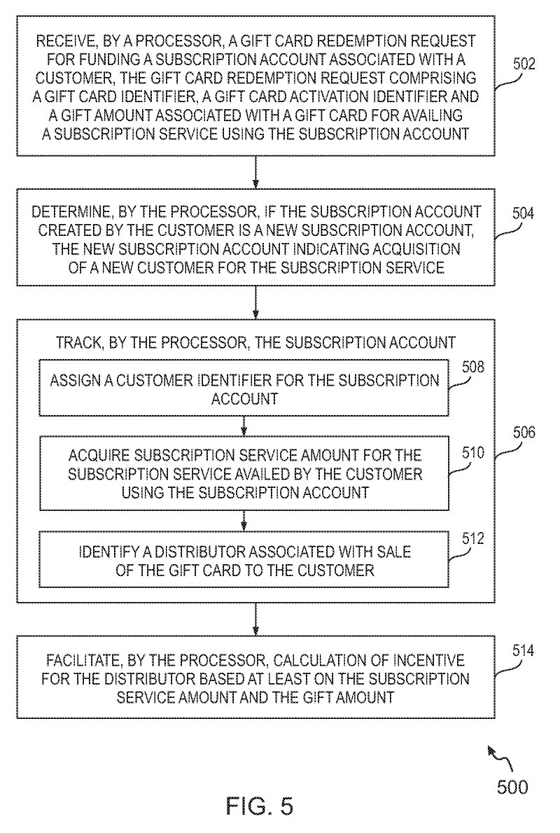

Referring now to FIG. 5, a flow diagram depicting an example method 500 of tracking and rewarding distributors of gift cards for subscription service is illustrated in accordance with an example embodiment. The operations of the method 500 are performed by a processor of the program manager 122. In another embodiment, the program manager 122 may be embodied in the issuer server 116 or the distributor server 120 and configured to perform the method 500. The sequence of operations of the method 500 need not to be necessarily executed in the same order as they are presented. Further, one or more operations may be grouped together and performed in form of a single step, or one operation may have several sub-steps that may be performed in parallel or in sequential manner.

At operation 502, the method 500 includes receiving, by a processor, a gift card redemption request for funding a subscription account associated with a customer. Herein it should be noted that the processor is a part of the program manager 122. The gift card redemption request comprises a gift card identifier and a gift amount associated with a gift card for availing a subscription service using the subscription account. The subscription service is provided by an issuer. When the user accesses an issuer interface to redeem the gift card for the subscription service, the issuer interface requests the user to either create a subscription account or login using credentials to the subscription account created prior by the user. When the user chooses to create a new subscription account and fund the subscription account using the gift card, the gift card redemption request is placed by the processor. The user may key in the gift card identifier associated with the gift card on the issuer interface.

At operation 504, the method 500 includes determining, by the processor, if the subscription account created by the customer is a new subscription account. The new subscription account indicating acquisition of a new customer for the subscription service.

At operation 506, the method 500 includes tracking, by the processor, the subscription account. The operation 506 can be performed by blocks 508, 510, 512.

At operation 508, the method 500 includes assigning, by the processor, a customer identifier for the subscription account. In an embodiment, the customer identifier is assigned by the processor for tracking the new subscription account created by the user. The processor tracks subscription details and payment transaction associated with the subscription account using the customer identifier assigned to the subscription account.

At operation 510, the method 500 includes acquiring subscription service amount for the subscription service availed by the customer using the subscription account. The issuer interface displays various subscription options for availing the subscription service to the user. For instance, subscription options may include options for the user to choose subscription time period, subscription content and subscription payment options. In an example, availing a subscription service, such as, soap operas offered by an issuer, the user may choose soap operas that are dramatic (subscription content) and avail the subscription service (soap operas) offered by the issuer for a year and pay for the subscription service availed for a year on a monthly basis. The issuer displays the subscription service amount based on the subscription options selected by the user. The subscription service amount is tracked by the processor and stored against the customer identifier in the processor.

At operation 512, the method 500 includes identifying, by the processor, a distributor associated with sale of the gift card to the customer. In an embodiment, the processor manages a table that maintains listings of gift card identifier, gift card activation identifier, an associated distributor, an associated distribution partner, an associated subscription account, customer identifier, subscription service amount, subscription service plan and gift card amount. For instance, when the user places a gift card redemption request to the processor, the user provides the gift card identifier. The processor uses the gift card identifier to identify the distributor and/or distribution partner who activated the gift card and thereby associate the distributor and/or distribution partner with the sale of the gift card to the user.

At operation 514, the method 500 includes facilitating, by the processor, calculation of incentive for the distributor based at least on the subscription service amount and the gift amount. The distributor is provided an incentive for sale of the gift card. The incentive is usually a one-time commission that is determined based on the gift amount of the gift card. If the distributor avails help from a distribution partner for sale of the gift card, the incentive received by the distributor is shared between the distributor and the distribution partner. Additionally, when the gift card is used to fund the subscription account for availing the subscription service, the distributor associated with activation and/or sale of the gift card is incentivized. The incentive is determined based on the subscription amount for the subscription service availed by the user. The incentive is provided in the form of monetary rewards and may be a one-time commission or an ongoing commission based on the subscription service and agreements between the distributor and the issuer. Optionally, the distributor may employ one or more distribution partners for sale of the gift card and the monetary reward based on the subscription account is shared between the distribution and the distribution partner. Calculating incentive for the distributor and/or distribution partner associated with the sale of the gift card has been explained in detail with reference to FIG. 4.

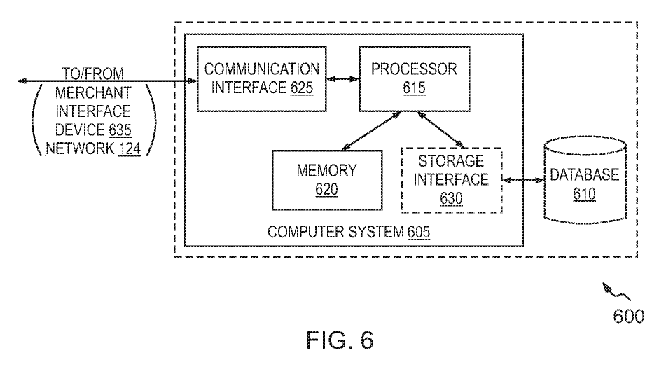

FIG. 6 is a block diagram of a server system 600 configured to track and reward distributors and/or distribution partners for sale of gift cards used for availing subscription services, in accordance with an example embodiment. Examples of the server system 600 include, but not limited to, the program manager 122, the issuer server 116 and the distributor server 120 illustrated in FIG. 1. The server system 600 includes a computer system 605 and a database 610.

The computer system 605 includes at least one processor 615 for executing instructions. Instructions may be stored in, for example, but not limited to, a memory 620. The processor 615 may include one or more processing units (e.g., in a multi-core configuration).

The processor 615 is operatively coupled to a communication interface 625 such that the computer system 605 is capable of communicating with a remote device such as a merchant interface device 635 (e.g., the merchant interface device 114) or communicate with any entity within the network 124. For example, the communication interface 625 may receive the gift card activation request from the merchant interface device 635, when the customer pays a gift amount that is to be loaded onto the gift card. The communication interface 625 may receive the gift card redemption request from the merchant interface device 635 when the customer chooses mode of payment as gift card for funding a subscription account such as to avail a subscription service offered by an issuer.

The processor 615 may also be operatively coupled to the database 610. The database 610 is any computer-operated hardware suitable for storing and/or retrieving data, such as, but not limited to, transaction details generated as part of sales activities conducted over the gift card including data relating to distributors, distribution partners (merchant facilities), customer information and balance amount in the gift card. The database 610 may also store a table comprising information related to a plurality of gift card identifiers. Each gift card identifier includes information corresponding to gift card activation identifier, an associated distributor, an associated distribution partner, an associated subscription account, customer identifier, subscription service amount, subscription service plan, gift card amount and monetary reward for each of a distributor and/or distribution partner. The database 610 may also include instructions for crediting incentives to distributor/distribution partner and account information of the distributor/distribution partner for providing the incentives. The database 610 may include multiple storage units such as hard disks and/or solid-state disks in a redundant array of inexpensive disks (RAID) configuration. The database 610 may include a storage area network (SAN) and/or a network attached storage (NAS) system.

In some embodiments, the database 610 is integrated within the computer system 605. For example, the computer system 605 may include one or more hard disk drives as the database 610. In other embodiments, the database 610 is external to the computer system 605 and may be accessed by the computer system 605 using a storage interface 630. The storage interface 630 is any component capable of providing the processor 615 with access to the database 610. The storage interface 630 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 615 with access to the database 610.

The processor 615 is configured to facilitate tracking of distributor and/or distribution partner associated with sale/activation of the gift card. The processor 615 is further configured to receive a gift card activation request and facilitate activation of the gift card. The processor 615 is further configured to perform one or more of the functions such as: receive a gift card redemption request, determine if the subscription account created by the user is a new account, assign a customer identifier for the subscription account, identify the distributor and/or distribution partner associated with sale of the gift card, track the subscription account and identify the subscription details and subscription amount of the subscription service and calculate monetary rewards for the distributor and/or the distribution partner for sale of the gift card and help acquisition of a new customer for the subscription service offered by an issuer. The processor 615 may also be configured to notify the merchant interface device 635 of the activation status of the gift card via the communication interface 625.

Various example embodiments disclosed herein are capable of tracking and rewarding distributors and/or distribution partners associated with sale of gift card for availing subscription services. Various example embodiments suggest techniques for incentivizing the distributor and/or distribution partner associated with activating and/or sale of the gift card to a user. Tracking of the user by assigning a customer identifier when the user accesses an issuer interface to create a subscription account for availing the subscription service ensures that the distributor and/or distribution partner are tracked down and incentivized additionally for aiding in acquisition of a new customer for the subscription service due to sale of the gift card. Further, maintenance of a table by the program manager and/or the issuer server ensures that the distributor and/or distribution partner are tracked down promptly and are rewarded sale of the gift card and thereby acquisition a new customer for the subscription service offered by the issuer. Moreover, such monetary rewards provide extra revenue for the distributor and/or distribution partner for sale of gift card.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 6. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims.

What is claimed is:

1. A method, comprising:
receiving, by a processor, a gift card redemption request for funding a subscription account associated with a customer, the gift card redemption request comprising a gift card identifier and a gift amount associated with a gift card for availing a subscription service using the subscription account;
determining, by the processor, if the subscription account created by the customer is a new subscription account, the new subscription account indicating acquisition of a new customer for the subscription service;
tracking, by the processor, the subscription account, by performing at least:
assigning a customer identifier for the subscription account;
acquiring a subscription service amount for the subscription service availed by the customer using the subscription account; and
identifying a distributor associated with sale of the gift card to the customer; and
facilitating, by the processor, calculation of an incentive for the distributor based at least on the subscription service amount and the gift amount.

2. The method as claimed in claim 1, further comprising:
receiving, by the processor, a gift card activation request prior to receiving the gift card redemption request, the gift card activation request comprising the gift amount to be loaded on the gift card and at least one of a proxy identifier and the gift card identifier of the gift card associated with the customer;
resolving, by the processor, the proxy identifier by mapping the proxy identifier to an associated gift card identifier;
facilitating, by the processor, activation of the gift card associated with the customer to generate a gift card activation identifier, by performing at least providing the gift card activation identifier to the distributor; and
storing, by the processor, the gift card identifier, the gift amount, the gift card activation identifier and the distributor associated with the sale of the gift card to the customer.

3. The method as claimed in claim 2, wherein storing further comprises, tracking a balance amount in the gift card of the customer after every purchase using the gift card.

4. The method as claimed in claim 1, wherein the distributor comprises one or more distribution partners for sale of the gift card to the customer.

5. The method as claimed in claim 4, wherein facilitating calculation further comprises awarding the incentive as monetary rewards to at least one of: the distributor; and the one or more distribution partners associated with sale of the gift card to the customer.

6. The method as claimed in claim 5, wherein the monetary rewards based on the gift amount are provided when the gift card is activated.

7. The method as claimed in claim 5, wherein the monetary rewards is based on the gift amount and the subscription service amount is provided when the customer avails the subscription service using the subscription account.

8. The method as claimed in claim 5, wherein the monetary rewards to the distributor and the one or more distribution partners is at least one of: a one-time incentive; and ongoing commission based on the subscription service availed by the customer using the gift card.

9. The method as claimed in claim 1, further comprising:
reporting, by the processor, the acquisition of the new customer to the distributor or the one or more distribution partners associated with the sale of the gift card to the customer.

10. The method as claimed in claim 1, further comprising:
facilitating, by the processor, creation of the subscription account via a subscription service interface on a user device associated with the customer.

11. A device, comprising:
a memory comprising stored instructions; and
at least one processor, configured to execute the stored instructions to cause the device to perform at least:
receiving a gift card redemption request for funding a subscription account associated with a customer, the gift card redemption request comprising a gift card identifier and a gift amount associated with a gift card for availing a subscription service using the subscription account;
determining if the subscription account created by the customer is a new subscription account, the new subscription account indicating acquisition of a new customer for the subscription service;
tracking the subscription account, by performing at least:
assigning a customer identifier for the subscription account;
acquiring a subscription service amount for the subscription service availed by the customer using the subscription account; and
identifying a distributor associated with sale of the gift card to the customer; and
facilitating calculation of an incentive for the distributor based at least on the subscription service amount and the gift amount.

12. The device as claimed in claim 11, wherein the device is further configured to:
receive a gift card activation request prior to receiving the gift card redemption request, the gift card activation request comprising the gift amount to be loaded on the gift card and at least one of a proxy identifier and the gift card identifier of the gift card associated with the customer;
resolve the proxy identifier by mapping the proxy identifier to an associated gift card identifier;
facilitate activation of the gift card associated with the customer to generate a gift card activation identifier, by performing at least providing the gift card activation identifier to the distributor; and
store the gift card identifier, by performing at least providing the gift amount, the gift card activation identifier and the distributor associated with the sale of the gift card to the customer.

13. The device as claimed in claim 12, wherein for storing the device is further caused to track a balance amount in the gift card of the customer after every purchase using the gift card.

14. The device as claimed in claim 11, wherein the distributor comprises one or more distribution partners for sale of the gift card to the customer.

15. The device as claimed in claim 14, wherein for facilitating calculation, the device is caused to award the incentive as monetary rewards to at least one of the distributor or the one or more distribution partners associated with sale of the gift card to the customer.

16. The device as claimed in claim 15, wherein the monetary rewards based on the gift amount and the subscription service amount is provided when the customer avails the subscription service using the subscription account.

17. The device as claimed in claim 15, wherein the monetary rewards based on the subscription amount is at least one of: a one-time incentive; and ongoing commission based on the subscription service availed by the customer using the gift card.

18. A method, comprising:
receiving, by a program manager, a gift card redemption request from an issuer server, the gift card redemption request comprising at least one of a gift card identifier and a gift card activation identifier of a gift card for funding a subscription account associated with a customer, the subscription account associated with a subscription service offered by the issuer server;
determining, by the program manager, if the subscription account created by the customer is a new subscription account by retrieving subscription account details from the issuer server, the new subscription account indicating acquisition of a new customer for the subscription service;
acquiring, by the program manager, a subscription service amount from the issuer server, the subscription service amount associated with the subscription service by tracking the new subscription account; and
calculating, by the program manager, a monetary reward for at least one distributor associated with the gift card based at least on the subscription service amount and the gift amount.

19. The method as claimed in claim 18, wherein tracking the new subscription account comprises:
assigning, by the program manager, a customer identifier for the new subscription account created by the customer for tracking of the new subscription account.

20. The method as claimed in claim 19, further comprising:
identifying, by the program manager, at least one distributor associated with sale of the gift card by tracking activation details of the gift card using the gift card activation identifier.
